(19) United States
(12) Patent Application Publication
(10) Pub. No.: US 2011/0099036 A1
(43) Pub. Date: Apr. 28, 2011

(54) Systems and methods for offering, scheduling, and coordinating follow-up communications regarding test drives of motor vehicles

(76) Inventors: Patrick Sarkissian, New York, NY (US); Matthew Mason, Phoenix, AZ (US)

(21) Appl. No.: 12/589,716

(22) Filed: Oct. 26, 2009

(51) Int. Cl. G06Q 10/00

(52) U.S. Cl. 705/5

(57) ABSTRACT

Systems and methods are provided for electronically offering, scheduling, and/or coordinating follow-up communications regarding test drives of motor vehicles. For example, in some embodiments of the present invention, computer-implemented systems and methods are provided for electronically scheduling a test drive of a motor vehicle for an end-user and facilitating a motor vehicle purchase or lease by the end-user subsequent to the test drive.

### FIELD OF THE INVENTION

Embodiments of the present invention relate generally to computer-implemented systems and methods for electronically offering, scheduling, and/or coordinating follow-up communications regarding test drives of motor vehicles. For example, in some embodiments of the present invention, computer-implemented systems and methods are provided for electronically scheduling a test drive of a motor vehicle for an end-user and facilitating a motor vehicle purchase or lease by the end-user subsequent to the test drive.

### BACKGROUND OF THE INVENTION

Traditionally and most commonly, consumers have been required to visit a motor vehicle dealership in order to test drive a motor vehicle. However, traveling to a dealership and meeting with sales personnel can be time consuming. There is also no guarantee that the dealership will have a vehicle of interest to the consumer (e.g., a particular make, model, and trim) in inventory and immediately available for a test drive. The costs and resources required to administer motor vehicle test drives also weigh in favor of dealerships providing less, rather than more, test drive opportunities. The general desire by some consumers to avoid car dealerships has also significantly reduced the number and variety of test drives taken by consumers. For example, a consumer may test drive only the one or more brands and/or models of motor vehicles with which the consumer is already most familiar. Unfortunately, these factors could lead to a different motor vehicle purchase or lease decision than would be made by a consumer if the consumer had more complete information and/or had test driven other vehicle(s) meeting the consumer's interests and objectives.

In view of the foregoing, it would be desirable to provide computer-implemented systems and methods for electronically offering, scheduling, and/or coordinating follow-up communications regarding test drives of motor vehicles.

### SUMMARY OF THE INVENTION

Embodiments of the present invention relate generally to computer-implemented systems and methods for offering, scheduling, and/or coordinating follow-up communications regarding test drives of motor vehicles. For example, contrary to the tendency for motor vehicle manufacturers and/or dealerships to limit the test drive opportunities available to consumers due to the associated costs and required resources, some embodiments of the present invention provide for an increased number of test drive opportunities, at times and/or under circumstances which are more convenient for consumers and more likely to increase the revenue of the manufacturers and/or dealerships.

In an aspect of some embodiments of the present invention, traditional barriers to providing and/or encouraging consumers to participate in motor vehicle test drives are eliminated or significantly reduced including, for example, the need for consumers to visit and interact with a motor vehicle dealership in order to schedule and complete a test drive. For example, in some embodiments of the present invention, consumers are provided with electronic offers to test drive motor vehicles. An electronic test drive offer may be selectively served (e.g., to a mobile device of an end user) and/or positioned in a page (e.g., web page or interactive television program guide interface display) where consumers are likely to start shopping for motor vehicles well before visiting a dealership. Advantageously, such offers can counteract the tendency for consumers to overlook brands and/or models of motor vehicles with which the consumers are traditionally less familiar, by encouraging consumers to consider alternative options (e.g., a challenger brand of motor vehicles and/or a new models) at times and/or under circumstances which are more convenient for the consumers.

In another aspect of some embodiments of the present invention, the test drive experience, scheduling, and/or follow-up is accomplished without the direct involvement of the motor vehicle manufacturer and/or dealership with the consumer. For example, the test drive offer can be provided to consumers electronically in displays (e.g., web pages) of third-party content publishers or within an interactive television program guide. As another example, electronic scheduling of the test drive can be completed without direct involvement of the motor vehicle manufacturer and/or dealership. In still another example, the vehicle for test drive may be provided to the consumer by a third-party car rental facility. Although this is contrary to the conventional belief that the manufacturer and/or dealership must maintain constant or near-constant communication with the consumer or else lose motor vehicle sales or lease revenue, it can advantageously increase consumer confidence in the authenticity of the test drive offer and that it will be conducted without interference from the manufacturer and/or dealership. This, in turn, can increase consumers' willingness to test drive motor vehicles and the likelihood of purchasing or leasing such vehicles subsequent to the test drives.

An aspect of some embodiments of the present invention provides an apparatus for electronically scheduling a test drive for an end-user over a communications network. The apparatus may include electronic memory (e.g., one or more databases) storing data identifying at least one motor vehicle available for a test drive. The apparatus may also include a test drive scheduling application in electronic communication with the electronic memory. The test drive scheduling application may be configured to receive a request for content from an end-user computer over a communications network. Such a request may be received by the test drive scheduling application in response to an end-user of the end-user computer selecting an offer for a motor vehicle test drive within an electronic interface display. In response to the request, the test drive scheduling application may be configured to provide data regarding scheduling a test drive of a motor vehicle to the end-user computer over the communications network for display to the end-user by the end-user computer.

For example, in some embodiments of the present invention, the electronic offer for the motor vehicle test drive may be displayed within a page (e.g., a page provided by a content publisher) over the communications network. Hypertext markup language (HTML) code may be associated with the electronic offer that directs the end-user computer (e.g., desktop computer, or mobile phone having a wireless application protocol (WAP) browser operating thereon) to request content from the test drive scheduling application in response to the end-user selection of the offer for the motor vehicle test drive.

As another example, the electronic test drive offer may be displayed within an interactive television program guide display displayed by a computer associated with the end user (e.g., a desktop computer, or a television such as an LCD display in electrical communication with a cable or set-top box). Such an interactive television program guide display may be accessed by an end user subsequent to the user selecting a “guide” or other option through a voice command, remote control, or keyboard and optionally navigating through one or more sub-menu displays within the guide. Upon the end user navigating to and selecting the electronic test drive offer within the program guide display, the end-user computer may issue a request for content to the test drive scheduling application. For example, in some embodiments, selection of the offer may cause the end-user computer (e.g., internet-enabled television) to submit a request over a communications network (e.g., internet) to a server that provides access to a page from which the user can schedule a test drive. In some embodiments, selection of the offer within the program guide may cause the end-user computer to submit a request for content to the test drive scheduling application, which may be implemented at least in part at a television main facility (e.g., facility operated by a cable or telephone company). Such a request may be submitted over the same or similar communications channel(s) utilized to perform other actions within the program guide such as, for example, ordering pay-per-view or video-on-demand programming.

In still another example, in some embodiments of the present invention the electronic test drive offer may be displayed by a mobile device associated with an end user such as, for example, a mobile phone, Blackberry device, or personal digital assistant. For example, an application (e.g., iPhone application) operating on the mobile device may cause the electronic test drive offer to be displayed, for example, as a function of a geo-targeting function which tracks the location of the mobile device. As another example, in some embodiments, the electronic test drive offer may be provided to the mobile device within a text, graphic, and/or video message. In some embodiments, selection of the electronic test drive offer may cause a (WAP) browser operating on the mobile device to request from a server of the test drive scheduling application a page from which the user can schedule a test drive. In some embodiments, the mobile device application may itself cause the display of the information regarding scheduling a test drive of a motor vehicle in response to the user selection of the electronic test drive offer. Scheduling and/or other functions (e.g., rescheduling, research, providing feedback, and/or any of the other interactive functions described herein) regarding the test drive may be completed through the use of the mobile device through, for example, communications between the test drive offer and/or scheduling applications and either the mobile application or a WAP-enabled browser on the mobile device.

In some embodiments of the present invention, the test drive scheduling application may be configured to provide data regarding at least one motor vehicle available for a test drive and at least one date for the test drive to the end-user computer for display by the end-user computer in one or more interactive, electronic displays. In some embodiments of the present invention, the test drive scheduling application may be configured to schedule a test drive of a motor vehicle for the end-user in response to receiving from the end-user computer an electronic selection from the end-user within the one or more interactive, electronic displays. For example, in some embodiments, the test drive scheduling application may provide data for a first interactive option to select a motor vehicle type and data for a second interactive option to select a date for a motor vehicle test drive to the end-user computer for display (e.g., alone or together with other information such as video or text) by the end-user computer in the one or more interactive, electronic displays. The test drive scheduling application may schedule the test drive of a motor vehicle for the end-user in response to receiving from the end-user computer electronic selections from the end-user in response to the first and second interactive options.

In some embodiments of the present invention, the test drive scheduling application may be configured to provide an electronic reminder (e.g., text, graphic, or video message, email, or a reminder provided by a mobile phone application) for a scheduled test drive of a motor vehicle to a computer or an electronic account associated with an end-user.

In yet further embodiments of the present invention, the test drive scheduling application may be configured to provide at least one electronic follow-up communication regarding the scheduled test drive, for example, to a computer or an electronic account associated with the end-user subsequent to passage or completion of the scheduled test drive by the end-user. For example, the follow-up communication(s) may include information regarding purchasing or leasing a motor vehicle within a region or area of the end-user. Alternatively or additionally, the follow-up communication(s) may include one or more interactive, electronic options requesting feedback from the end-user regarding the scheduled test drive. Based at least in part on information provided electronically by the end-user in response to the one or more interactive, electronic options, the test drive scheduling application may provide additional data regarding purchasing or leasing one or more motor vehicles for electronic display to the end-user (e.g., suggestions regarding other vehicle(s) which may be of interest to the end-user).

In some embodiments of the present invention, the test drive scheduling application may initiate the electronic follow-up communication(s) to the end-user in response to receiving over the communications network from a motor vehicle source facility an electronic notification that the scheduled test drive was completed by the end-user.

In some embodiments of the present invention, the test drive scheduling application may provide data regarding the scheduled test drive over the communications network to at least one computer associated with at least one of a motor vehicle manufacturer and a motor vehicle dealership.

Additional aspects of some embodiments of the present invention provide methods and computer-readable media for electronically offering, scheduling, and/or coordinating follow-up communications regarding test drives of motor vehicles. For example, a computer-implemented method according to some embodiments of the present invention includes storing in electronic memory data identifying at least one motor vehicle available for a test drive, and receiving with a computer comprising a server an electronic request for content from an end-user computer over a communications network. The electronic request may be received by the computer in response to an end-user of the end-user computer selecting an offer for a motor vehicle test drive within an electronic interface display. The computer-implemented method may further include providing, in response to the request and with the computer comprising the server, data from the electronic memory regarding scheduling a test drive of a motor vehicle to the end-user computer over the communications network for display to the end-user by the end-user computer. In some embodiments, the computer-implemented method may include scheduling the test drive for the end-user based on information submitted by the end-user through an electronic interface and/or initiating follow-up communications regarding the test drive.

### BRIEF DESCRIPTION OF THE DRAWINGS

For a better understanding of the present invention, reference is made to the following description, taken in conjunction with the accompanying drawings, in which like reference characters refer to like parts throughout, and in which:

FIG. 1 is a block diagram of a system for offering, scheduling, and/or coordinating follow-up communications regarding test drives of motor vehicles in accordance with an embodiment of the present invention;

FIG. 2 is a flowchart of illustrative stages involved in offering, scheduling, and/or coordinating follow-up communications regarding test drives of motor vehicles in accordance with an embodiment of the present invention;

FIG. 3 is an illustrative interactive, electronic display that includes a motor vehicle test drive offer selectable electronically by an end-user and other information about motor vehicle(s) in accordance with an embodiment of the present invention;

FIG. 4 is an illustrative interactive, electronic display through which an end-user can schedule a motor vehicle test drive electronically in accordance with an embodiment of the present invention;

FIG. 5 is an illustrative interactive, electronic display that includes information about a test drive scheduled for an end-user in accordance with an embodiment of the present invention; and

FIG. 6 is an illustrative interactive, electronic display through which an end-user can review and provide information regarding a test drive completed by the end-user and/or information regarding purchasing or leasing a motor vehicle in accordance with an embodiment of the present invention.

### DETAILED DESCRIPTION OF THE INVENTION

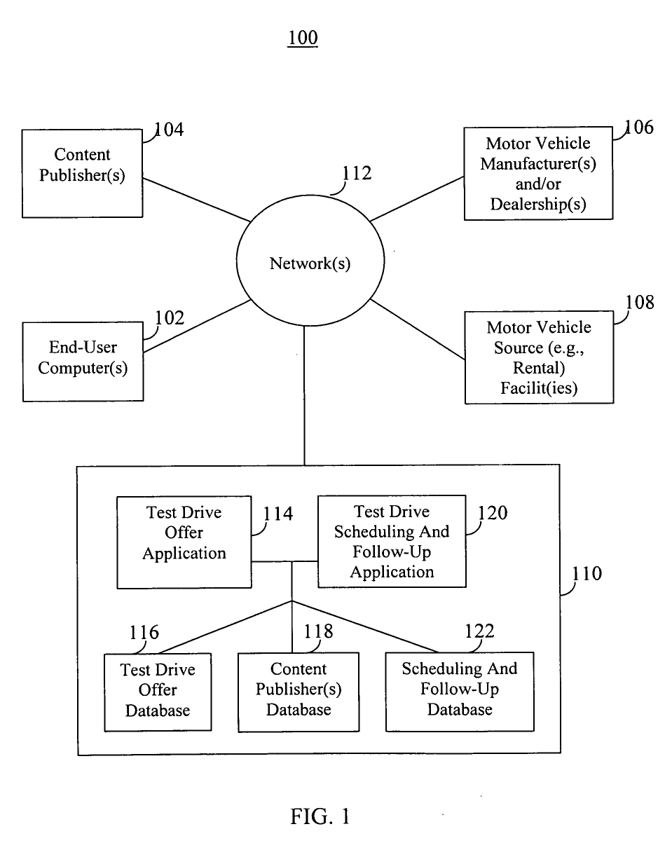

FIG. 1 is a block diagram of a system 100 for offering, scheduling, and/or coordinating follow-up communications regarding test drives of motor vehicles in accordance with an embodiment of the present invention. System 100 may include one or more end-user computers 102, one or more content publishers 104 (e.g., publishers of information regarding motor vehicles), one or more motor vehicle manufacturers and/or dealerships 106, one or more motor vehicle source facilities 108 (e.g., motor vehicle rental facilities), and test drive offer, scheduling, and follow-up (“test drive”) system 110, all of which (in some embodiments) communicate with one another over one or more networks 112 (e.g., internet). Each of end-user computer(s) 102, content publisher(s) 104, motor vehicle manufacturer(s) 106, dealership(s) 106, motor vehicle source facilit(ies) 108, and test drive system 110 may be in electrical communication with network(s) 112 via a suitable communications capability such as, for example, a cable or satellite connection, a local area network (“LAN”), any other suitable wired, wireless, or optical connection, or a combination thereof.

Each end-user computer 102 may include suitable computing equipment for, for example, accessing content (e.g., web pages) over network(s) 112, displaying information regarding test drive offers to end-user(s) of user computer 102 in one or more displays, and providing over network(s) 112 information from an end-user in response to the one or more displays. For example, end-user computer 102 may be a desktop computer. In other examples, end-user computer 102 may be a laptop computer, telephone (e.g., mobile phone having a WAP browser operating thereon and/or an application facilitating some or all of offering, scheduling, and/or coordinating follow-up communications regarding test drives of motor vehicles), personal digital assistant (“PDA”), BlackBerry device, or any other suitable computing device. In some embodiments, end-user computer 102 may have a browser (e.g., Internet Explorer, Safari, Netscape Navigator, Mozilla Firefox) operating thereon for facilitating communications over network(s) 112. The browser may access and read marked-up documents (e.g., HTML documents) from, for example, a content publisher 104, test drive system 110, motor vehicle manufacturer 106, dealership 106, and/or motor vehicle source facility 108 and then translate and render those documents into pages that can be viewed by an end-user of computer 102.

Each content publisher 104 may be, for example, a publisher of page(s) (e.g., web pages) over network(s) 112. In some embodiments of the present invention, content publisher 104 may publish information regarding motor vehicles. For example, one content publisher 104 may include the computing system responsible for publishing the web pages viewable at http://www.edmunds.com. As another example, another content publisher 104 may include the computing system responsible for publishing the web pages viewable at http://www.kbb.com (Kelley Blue Book). In some embodiments, each content publisher 104 may include one or more web server(s) and/or processor(s) for receiving and responding to requests from end-user computers 102 for access to the page(s) provided by the content publisher. End-users of user computers 102 may request access to a given page by, for example, typing a locator (e.g., Universal Resource Locator (“URL”)) for that page within an address region of a display (e.g., browser display) or by selecting a link for the page from a list of search results (e.g., Google search results).

One or more page(s) provided by content publisher 104 may have space allocated thereon for the display of offers including, for example, test drive offers associated with test drive system 110. For example, in some embodiments of the present invention, a test drive offer displayed on a page provided by content publisher 104 may have hypertext markup language (“HTML”) code associated therewith. Upon selection of the test drive offer by an end-user of user computer 102, the HTML code associated with the test drive offer may cause end-user computer 102 to request content from test drive system 110 (e.g., application 120). In response to the request, test drive system 110 may return to end-user computer 102 data for a page that includes additional information and options regarding the offer.

Each motor vehicle manufacturer (e.g., KIA) 106, dealership 106, and/or motor vehicle source facility 108 (e.g., Enterprise) may publish page(s) (e.g., web pages) over network(s) 112 and/or otherwise communicate with end-user computer 102 and/or test drive system 110. Each motor vehicle manufacturer 106, dealership 106, and/or motor vehicle source facility 108 may include one or more server(s) and/or processor(s) for coordinating such communications. In some embodiments of the present invention, one or more page(s) provided by motor vehicle manufacturer 106, dealership 106, and/or motor vehicle source facility 108 may have space allocated thereon for the display of offers including, for example, test drive offers associated with test drive system 110. Additional details regarding the manner in which a motor vehicle manufacturer 106, dealership 106, and/or motor vehicle source facility 108 may communicate electronically with test drive system 110 and/or end-user computer 102 according to some embodiments of the present invention are provided below.

Test drive system 110 may include test drive offer application 114, test drive offer database 116, content publishers database 118, test drive scheduling and follow-up application 120, and/or scheduling and follow-up database 122. Test drive offer application 114 may include any suitable hardware, software, or combination thereof for, for example, receiving and responding to electronic requests for test drive offers received by application 114 via network(s) 112. For example, test drive offer application 114 may include one or more web server(s) and/or processor(s) for receiving and responding to such requests. In some embodiments of the present invention, responsive to one or more requests, test drive offer application 114 may provide one or more motor vehicle test drive offers for display within page(s) provided by one or more content publishers 104 which are not the motor vehicle manufacturer and/or a dealership. Advantageously, this can increase consumer confidence in the authenticity of the test drive offer and that it will be conducted without interference from the manufacturer and/or dealership. In other embodiments of the present invention, test drive offer application 114 may provide one or more motor vehicle test drive offers for display within page(s) provided by motor vehicle manufacturer(s) 106, dealership(s) 106, and/or motor vehicle source facilit(ies) 108.

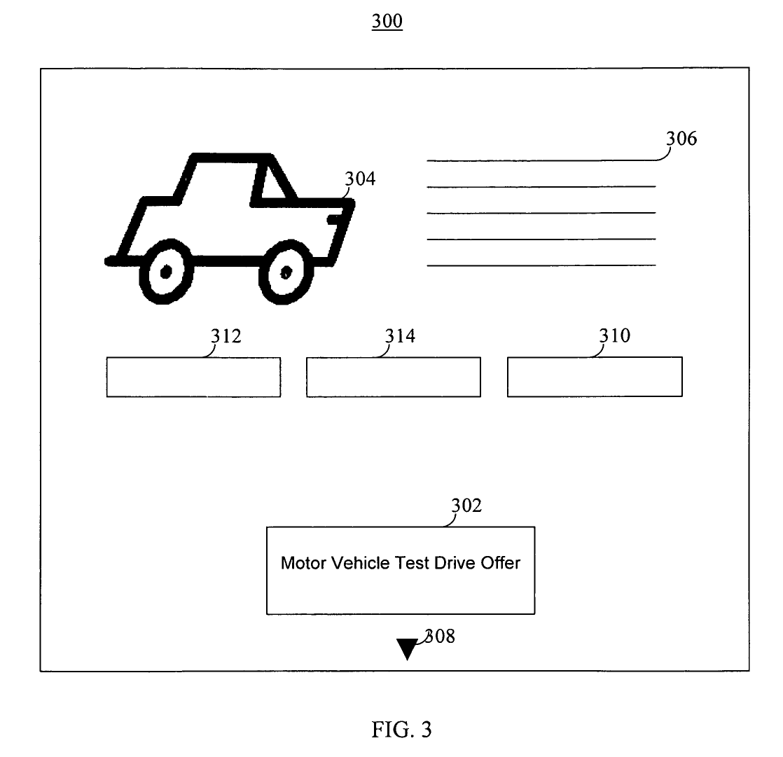

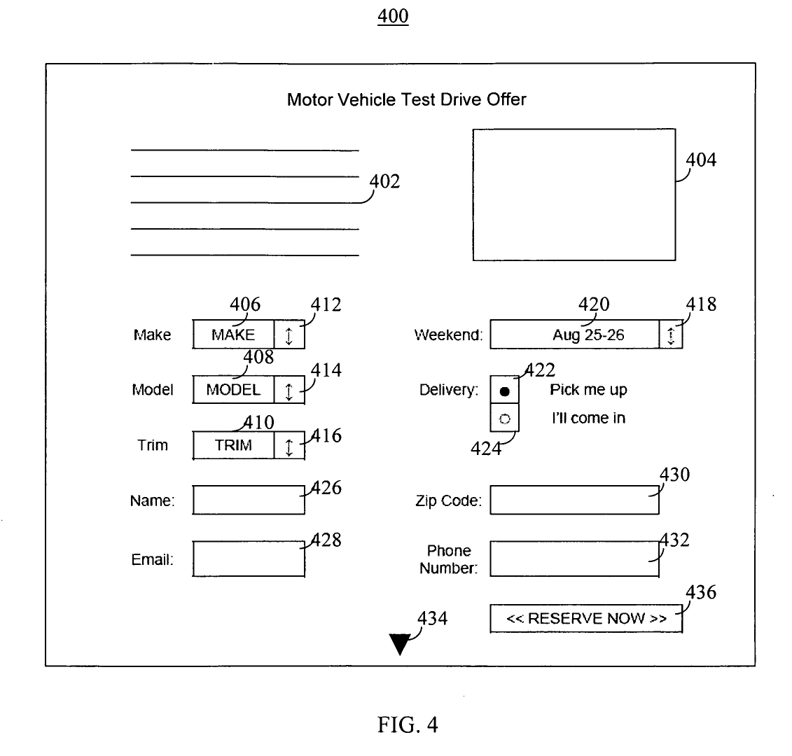

Test drive offer database 116 may store motor vehicle test drive offers for display within the pages provided by content publisher(s) 104, motor vehicle manufacturer(s) 106, motor vehicle dealership(s) 106, and/or motor vehicle source facilit(ies) 108, which pages can be accessed by end-users of computers 102. Each test drive offer may include text, graphic(s), video, and/or interactive options capable of receiving input from an end-user of computer 102. Each test drive offer may be provided in one or more electronic interface displays or partial displays (e.g., banners, panels, overlays) of information such as, for example, a first display (e.g., partial display 302 in FIG. 3) the selection of which by an end-user of computer 102 causes the display of a second display (e.g., FIG. 4) from which the end-user can schedule a test drive. Alternatively or additionally, in some embodiments of the present invention, database 116 may store data associated with the test drive offers such as, for example, data identifying particular page(s) in which respective test drive offer(s) are to be displayed (e.g., data associating a 2010 Kia Forte test drive offer with an Edmunds.com 2010 Kia Forte page) and/or data identifying the years, makes, models, trims and/or other specifications regarding motor vehicles (e.g., specifications related to engine performance and/or gas mileage) associated with the test drive offers. In some embodiments, application 114 may use such data to determine which, if any, test drive offers are relevant to the contents of given pages and/or end-user preferences or characteristics. Alternatively or additionally, database 116 may store data identifying the fee(s) if any to be paid by end-users for the test drives, data identifying the URL(s) to which an end-user computer 102 is to be directed upon selection of the test drive offer(s) by end-users, and/or any other suitable data.

Test drive offers may be provided for display in page(s) provided by content publisher(s) 104, motor vehicle manufacturer(s) 106, dealership(s) 106, and/or motor vehicle source facilit(ies) 108 according to any suitable approach or combination of approaches. In some embodiments of the present invention, test drive offer application 114 may provide content publisher(s) 104, motor vehicle manufacturer(s) 106, dealership(s) 106, and/or motor vehicle source facilit(ies) 108 with test drive offers for display within their respective page(s). Such offers may be provided by application 114 in advance of end-user requests for access to such page(s) and/or in real-time as a result of such requests. For example, in response to an end-user of computer 102 requesting a page from content publisher 104, content publisher 104 may request content from application 114. The request to application 114 may include, for example, data identifying the page (e.g., by URL) requested by the end-user, data identifying a particular test drive offer, data regarding the subject matter of the requested page, and/or data regarding preferences and/or characteristics of the end-user (e.g., likes, dislikes, page viewing history). Such data regarding the end-user may be collected, for example, by content publisher 104 through the use of cookies placed by the publisher within the memory of an end-user computer 102. Application 114 may utilize some or all of the data in the request to select and return (e.g., from database 116) a test drive offer to content publisher 104 for display within a page. For example, application 114 may select and return a test drive offer which, based on a comparison with stored data regarding the test drive offer (e.g., data stored in database 116), is determined to correlate with the end-user preferences and/or characteristics and/or the subject matter of the requested page as identified by data in the request. In another approach according to some embodiments of the present invention, application 114 may provide test drive offer(s) directly to the end-user computer 102 for display, for example, by a browser operating on computer 102.

In still other embodiments of the present invention, a content publisher 104 and/or motor vehicle source facility 108 may display test drive offer(s) in their respective page(s) as a result of or in accordance with an arrangement with a motor vehicle manufacturer and/or dealer 106. Such an arrangement may provide that the content publisher 104 and/or motor vehicle source facility 108 is paid a fee such as, for example, a fee per test drive offer impression on a page and/or click-through by an end-user. In such an embodiment or in other arrangements, test drive offer application 114, database 116, and/or database 118 may be located at and/or some or all of their respective functions performed at content publisher 104, motor vehicle source facility 108, and/or another facility (e.g., manufacturer and/or dealer 106). For example, in response to an end-user request from computer 102 to content publisher 104 for access to a page, one or more server(s) and/or processor(s) of content publisher 104 may select a test drive offer (e.g., stored locally in memory at publisher 104) and provide computer 102 with both data for the page and the test drive offer. For example, each time a given page is served to an end-user computer 102, a test drive offer created specifically for that page may also be served to computer 102 for simultaneous display by computer 102 within the page. In some embodiments of the present invention, content publisher 104 and/or source facility 108 may select a test drive offer for display within a page in real-time based on, for example, a determination by the publisher 104 and/or source facility 108 that the subject matter of the page and/or the preferences and/or characteristics of the end-user correlate with stored data regarding the test drive offer (e.g., data stored locally at content publisher 104 and/or source facility 108).

Content publishers database 118 may store data regarding content publisher(s) 104, motor vehicle manufacturer(s) 106, motor vehicle dealership(s) 106, and/or motor vehicle source facilit(ies) 108 within system 100 including, for example, data identifying page(s) provided by these publishers (e.g., a list of their respective URLs) and/or data regarding the content of the page(s). Some or all of such data may be used by application 114 to select appropriate test drive offer(s) for display within the page(s), for example, as an alternative to or in addition to receiving such data in real-time (e.g., from content publisher(s) 104) in response to requests for access to pages by end-users of computers 102. Alternatively or additionally, database 118 may store rules data such as, for example, minimum or maximum number(s) of test drive offers that can be displayed within page(s), maximum number(s) of test drive offers that can be scheduled and/or completed, and/or actual number(s) of test drive offers scheduled and/or completed by end-users to date. System 110 (e.g., application 114 and/or application 120) may utilize such rules data, for example, to guard against or prevent over-booking of test drives by end-users (e.g., limiting the number of impressions of test drive offer(s) and/or the number of test drives scheduled through system 110). In some embodiments of the present invention, database 118 may store data regarding preferences of content publisher(s) 104, motor vehicle manufacturer(s) 106, motor vehicle dealership(s) 106, and/or motor vehicle source facilit(ies) 108 such as, for example, type(s) of offers which are eligible and/or ineligible for display within their respective pages (e.g., test drive offers associated with a particular motor vehicle manufacturer or dealership). In the embodiment of FIG. 1, databases 116 and 118 are shown as separate databases, although it will be understood that alternative arrangements are possible. For example, in some embodiments of the present invention, a single database may be provided that stores the information just described as being stored in databases 116 and 118.

Test drive scheduling and follow-up application 120 may include any suitable hardware, software, or combination thereof (e.g., one or more server(s) and/or processor(s)) for, for example, receiving and responding to electronic requests to schedule motor vehicle test drives received by application 120 via network(s) 112. For example, in response to an end-user selection of a test drive offer (e.g., offer 302 in FIG. 3), a request for more information regarding a test drive may be submitted to application 120. For example, HTML code associated with the test drive offer may direct end-user computer 102 to request a page (e.g., URL) from application 120. In response to such request, application 120 may return data regarding scheduling a test drive for display within an electronic interface display (e.g., FIG. 4) by a browser operating on end-user computer 102. For example, in some embodiments of the present invention, the data returned by application 120 may be displayed in a pop-up display that at least partially overlays the page that includes the test drive offer. Based (e.g., in part) on information submitted by an end-user through computer 102 to application 120 via the electronic interface display, application 120 may schedule a motor vehicle test drive for the end-user.

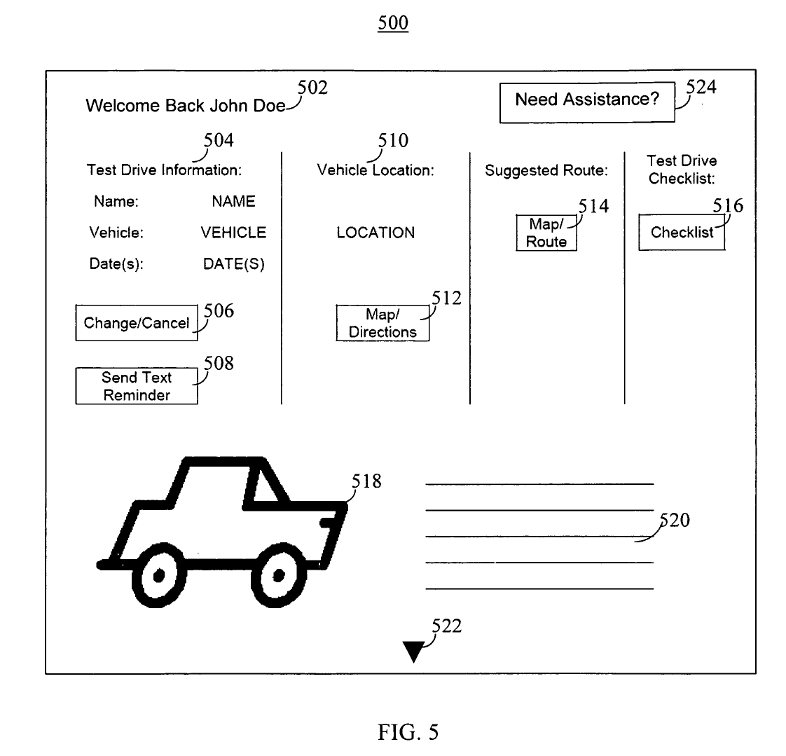

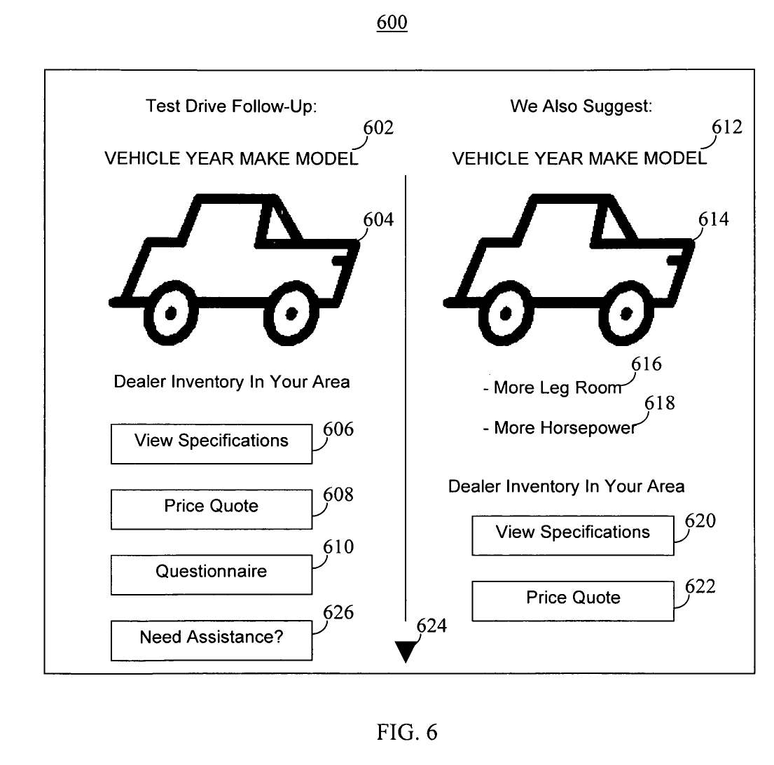

Alternatively or additionally, application 120 may include any suitable hardware, software, or combination thereof for, for example, initiating, receiving, and responding to communications to and/or from end-user computer(s) 102, motor vehicle manufacturer(s) 106, motor vehicle dealership(s) 106, and/or motor vehicle source facilit(ies) 108 regarding motor vehicle test drives and/or the purchase and/or lease of motor vehicles. For example, subsequent to application 120 scheduling a motor vehicle test drive for an end-user, application 120 may transmit a confirmation and/or other data regarding the test drive to end-user computer 102, motor vehicle source facilit(ies) 108 (e.g., the motor vehicle source facility scheduled to provide the motor vehicle for use in the test drive), motor vehicle manufacturer(s) 106 (e.g., the manufacturer of the motor vehicle of the test drive), and/or motor vehicle dealership(s) 106 (e.g., the dealership(s) located within the area or region of the end-user where the same or similar type of motor vehicle is available for purchase and/or lease). Alternatively or additionally, application 120 may email or otherwise provide a notification and/or other information to email address(es) and/or account(s) associated with the end-user, motor vehicle source facilit(ies) 108, motor vehicle manufacturer(s) 106, and/or motor vehicle dealership(s) 106. For example, such information may be provided within account spaces (e.g., FIG. 5) having user names and passwords administered by test drive system 110 and accessible over network(s) 112. As another example, in some embodiments of the present invention, application 120 may initiate follow-up communication(s) (e.g., FIG. 6) to end-users requesting feedback regarding a motor vehicle test drive completed by the end-user through the use of system 110 and/or providing price quote(s) for the same, similar, and/or other motor vehicle(s).

In the embodiment of FIG. 1, applications 114 and 120 are shown as being separate applications, although it will be understood that alternative arrangements are possible. For example, in some embodiments of the present invention, the same one or more server(s) and/or processor(s) responsible for providing motor vehicle test drive offers may also schedule motor vehicle test drives and/or initiate, receive, and/or respond to communications regarding test drives, purchases, and/or leases of motor vehicles. In some embodiments of the present invention, application 114, application 120, and/or databases 116, 118, and/or 122 may be located at, and/or some or all of their respective functions performed locally at (e.g., by one or more server(s), processor(s), and/or memory of), motor vehicle source facilit(ies) 108, motor vehicle manufacturer(s) 106, motor vehicle dealership(s) 106, content publisher(s) 104, and/or other facilit(ies).

Scheduling and follow-up database 122 may store data regarding end-users and/or computers 102, motor vehicle source facilit(ies) 108, motor vehicle manufacturer(s) 106, and/or motor vehicle dealership(s) 106 involved in or otherwise related to test drives that are available, scheduled, and/or completed through the use of test drive system 110. For example, database 122 may store data identifying the zip code, other location and/or contact information, and/or data identifying test drive availability (e.g., dates and vehicle make(s), model(s), and trim(s) available) associated with each motor vehicle source facility 108 affiliated with system 110. Such data may be used by system 110 (e.g., application 120), for example, to provide the availability of motor vehicle test drives within end-users' areas or regions (e.g., same and/or surrounding zip codes(s)) for display to the end-user(s) in one or more electronic interface displays (e.g., FIGS. 4 and/or 5).

As another example, database 122 may store the data identifying zip code and/or other location and/or contact information (e.g., phone number, email address, and/or account information for an account administered by system 110) for each end-user who has scheduled and/or completed a motor vehicle test drive through system 110. Data identifying or otherwise regarding users that have completed test drives may be communicated from, for example, motor vehicle source facilit(ies) 108 to test drive system 110 over network(s) 112 and stored in database 122. Such data may be used, for example, by application 120 to initiate (e.g., trigger the onset of) follow-up electronic communication(s) to the end-users. Alternatively or additionally, database 122 may store data associated with motor vehicle dealership(s) and/or manufacturer(s) 106 such as, for example, location data such as zip code and street address, motor vehicle inventory and/or availability data, motor vehicle pricing data, and/or data identifying or otherwise pertaining to eBay listings of motor vehicles listed by such dealerships and/or manufacturers 106. Such data may be used by application 120, for example, to identify in follow-up communication(s) to end-user(s) the dealership(s) and/or manufacturer(s) 106 that have motor vehicles available (e.g., available immediately in inventory, on a per-order basis, or via an eBay listing) which may be of interest to the end-user. In some embodiments of the present invention, database 122 may store data identifying end-users and/or numbers of end-users who, subsequent to a test drive through system 110, have completed a purchase and lease of a motor vehicle such as, for example, the same or similar (e.g., same manufacturer) vehicle as used in the test drive. Application 120 may report statistics regarding such data periodically and/or electronically to motor vehicle manufacturer(s) and/or dealership(s) 106, for example, by making such data available within account spaces administered by system 110 and accessible by manufacturer(s) and/or dealership(s) 106.

In still another example, in some embodiments of the present invention, database 122 may store data identifying rebate(s) or/or discount(s), if any, available through motor vehicle manufacturer(s) 106. Such information may be used by application 120, for example, to provide end-users with accurate price quotes for motor vehicles for display within the electronic interface displays (e.g., FIGS. 4, 5, and/or 6). In the embodiment of FIG. 1, database 122 is shown as being separate from databases 116 and 118, although it will be understood that alternative arrangements are possible. For example, in some embodiments of the present invention, a single database may be provided that stores the information just described as being stored in databases 116, 118, and 122.

In some embodiments of the present invention, the electronic test drive offer may be displayed within an interactive television program guide display displayed by end-user computer 102. In such embodiments, content publisher 104 may be a main facility of a cable or telephone company which provides television programming, data, and/or other content to end-user computer 102, including the data displayed by end-user computer 102 within the program guide. End-user computer 102 may include, for example, a desktop computer, or a cable or set-top box connected to a display such as a LCD display or other television display. Upon the end user navigating to and selecting the electronic test drive offer within the program guide display, the end-user computer 102 may issue a request for content to test drive scheduling application 120. For example, in some embodiments, selection of the offer may cause the end-user computer (e.g., internet-enabled television) to submit a request over network(s) 112 (e.g., internet) to a server of application 120 that provides access to a page from which the user can schedule a test drive. In some embodiments of the present invention, selection of the electronic test drive offer within the program guide display may cause end-user computer 102 to submit a request for content to the test drive scheduling application 120, which may be implemented at least in part at a television facility (e.g., facility operated by a cable or telephone company). Such a request may be submitted over the same or similar communications channel(s) 112 utilized to perform other actions within the program guide such as, for example, ordering pay-per-view or video-on-demand programming. In some embodiments, in response to the request, test drive scheduling application 120 may provide data regarding scheduling a test drive, which may be displayed to the end-user with the interactive television program guide. For example, test drive scheduling application 120 located at or otherwise in communication with the television facility (e.g., one or more servers at the television facility) may provide data regarding at least one motor vehicle available for a test drive and at least one date for the test drive for display by the interactive television program guide to the end-user. The interactive television program guide running on end-user computer 102 may display at least a portion of such information in one or more interactive television program guide displays. Alternatively or additionally, in some embodiments, functions such as rescheduling or modifying the terms of a test drive, providing feedback regarding a test drive, and/or receiving follow-up communications subsequent to a test drive may be displayed in and carried out through the interactive television program guide, which is in electrical communication with application 120 and/or application 114 over network(s) 112. Scheduling of a test drive may cause a notification to be sent, for example, to the facility 108 which will provide the vehicle for the test drive. The interactive television program guide according to some embodiments of the present invention may include any suitable hardware (e.g., processor(s) and/or memory), software, or combination thereof for performing the functions just described.

In some embodiments of the present invention, the electronic test drive offer may be displayed by a mobile device 102 associated with an end user such as, for example, a mobile phone, Blackberry device, or personal digital assistant. For example, an application (e.g., iPhone application) operating on mobile device 102 may cause the electronic test drive offer to be displayed, for example, as a result of a geo-targeting function which tracks the location of the mobile device. The application operation on mobile device 102 may be in electronic communication with test drive offer application 114 and/or test drive scheduling application 120. For example, application 114 may cause the display of an electronic test drive offer on mobile device 102 as a result of application 114 determining (e.g., through communication(s) with the application operating on mobile device 102) that device 102 is near (e.g., within a predetermined distance of) of motor vehicle source facility 108 and/or dealership 106. The location of facilit(ies) 108 and/or 106 and/or other points of interest may be stored in, for example, database 116. Test drive offer application 114 and/or test drive scheduling application 120 may track or otherwise receive data regarding the location of mobile device 102 through the use of location-enabled functionality or a global positioning system (GPS). As another example, in some embodiments, the electronic test drive offer may be provided to the mobile device within a text, graphic, and/or video message (e.g., subsequent to an end-user opting or otherwise consenting to receive such electronic offers). In some embodiments, selection of the electronic test drive offer displayed by the mobile application or within a message (e.g., text message) may cause a (WAP) browser operating on the mobile device to request from a server of test drive scheduling application 120 a page from which the user can schedule a test drive. In some embodiments, the application operating on the mobile device may itself display the information regarding scheduling a test drive of a motor vehicle in response to the user selection of the electronic test drive offer (e.g., upon receipt of such information from application 120). Scheduling and/or other functions (e.g., rescheduling, research, providing feedback, and/or any of the other interactive functions described herein) regarding the test drive may be completed through the use of mobile device 102 through, for example, communications between applications 114 and/or 120 and either the application operating on device 102 or a WAP-enabled browser of device 102. Scheduling of a test drive may cause a notification to be sent, for example, to the facility 108 which will provide the vehicle for the test drive. The application operating on mobile device 102 according to some embodiments of the present invention may include any suitable hardware (e.g., processor(s) and/or memory), software, or combination thereof for performing the functions just described.

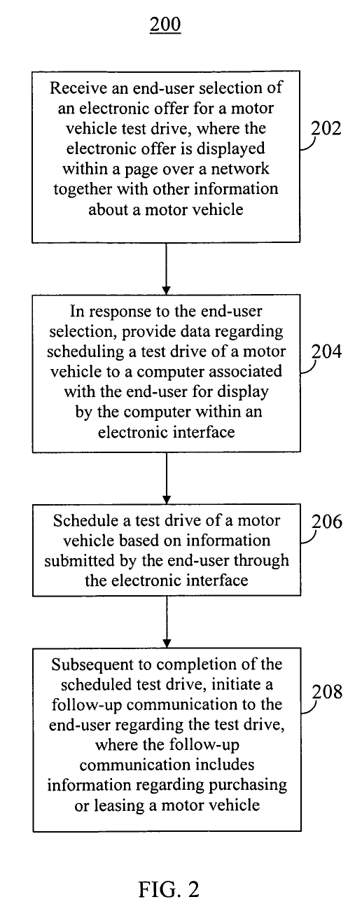

FIG. 2 is a flowchart 200 of illustrative stages involved in offering, scheduling, and coordinating follow-up communications regarding test drives of motor vehicles in accordance with an embodiment of the present invention. At stage 202, an end-user selection of an electronic offer for a motor vehicle test drive is received. Such an offer may be displayed, for example, within a page over a network together with other information about a motor vehicle (e.g., the same motor vehicle as identified in the test drive offer). For example, application 120 (FIG. 1) may receive a request for access to a page provided by application 120, where the request is generated as a result of an end-user selection of (e.g., pointing and clicking a pointer or cursor over) a test drive offer displayed within a page provided by content publisher 104, motor vehicle manufacturer 106, motor vehicle dealership 106, or motor vehicle source facility 108. In some embodiments, HTML code associated with the test drive offer may direct an end-user computer 102 to request a page (e.g., URL) provided by application 120 upon selection of the test drive offer by the end-user. In other embodiments, the electronic test drive offer may be displayed within a display of an interactive television program guide. Such an interactive television program guide display may be accessed by an end user subsequent to the user selecting a “guide” or other option through a voice command, remote control, or keyboard and optionally navigating through one or more sub-menu displays within the guide. For example, upon the end user navigating to and selecting the electronic test drive offer within the program guide display, the end-user computer may issue a request for content to test drive scheduling application 120. In still other embodiments, the electronic test drive offer may be displayed on a mobile device 102 (e.g., by a mobile application operating thereon or within a text message). For example, in response to mobile device 102 coming within a predetermined distance from a motor vehicle source facility 108 or dealership 106, the electronic test drive offer may be displayed (e.g., “Select this offer to stop in at the rental facility close by for a free test drive.”) Selection of the offer may cause mobile device 102 to issue a request to application 120.

At stage 204, in response to the end-user selection of the electronic test drive offer, data regarding scheduling a test drive of a motor vehicle and/or other data may be provided to a computer associated with the end-user for display by the computer within an electronic interface in one or more displays (e.g., web page(s), interactive television program guide display(s), and/or within an interface provided by an application operating on a mobile device 102). For example, in response to an end-user selection of test drive offer 302 (FIG. 3), application 120 may provide data for use in generating the electronic interface display of FIG. 4 and/or other data to end-user computer 102.

At stage 206, a test drive of a motor vehicle may be scheduled and/or other action(s) taken based on information submitted by an end-user through the electronic interface. For example, in response to information submitted to application 120 by an end-user via the electronic interface display of FIG. 4 and/or other display(s) presented to the end-user by computer 102 (e.g., by a browser or mobile application operating on computer 102), application 120 may schedule a motor vehicle test drive on behalf of the end-user. In some embodiments of the present invention, the test drive may be scheduled electronically for date(s), time(s), a location, and/or under other circumstances selected by the end-user through the electronic interface.

At stage 208, subsequent to the scheduling and/or completion of the test drive, a follow-up communication may be initiated to the end-user regarding the test drive. In some embodiments of the present invention, the follow-up communication may include information regarding purchasing or leasing a motor vehicle. For example, after passage of the date(s) of the scheduled test drive (e.g., automatically three days after the date(s) scheduled for the test drive), application 120 may send an email, text message, and/or initiate other electronic communication(s) (e.g., FIG. 6) to the end-user. In some embodiments of the present invention, application 120 may issue such follow-up communication(s) to end-user(s) only after receiving a notification (e.g., from motor vehicle source facility 108) that the test drive was actually completed. This can prevent such follow-up communications from being sent to end-users who did not complete a scheduled test drive. In some embodiments of the present invention, application 120 may issue the same or an alternate follow-up communication (e.g., “Sorry We Missed You”) to such end-users. As an alternative or in addition to the actions taken at stage 208, in some embodiments of the present invention, one or more electronic communications may be provided to one or more motor vehicle manufacturer(s) 106, motor vehicle dealership(s) 106, motor vehicle source facilit(ies) 108, and/or content publisher(s) 104 (e.g., communications notifying dealership(s) and/or manufacturer(s) 106 regarding results and/or end-user feedback regarding test drive(s)).

FIGS. 3-6 are illustrative interactive, electronic displays which may be provided for display to an end-user in order to offer, schedule, and/or follow-up regarding test drives of motor vehicles in accordance with some embodiments of the present invention. FIG. 3 is an illustrative interactive, electronic display 300 that includes a motor vehicle test drive offer 302 selectable by an end-user as well as other information (304, 306) about motor vehicle(s). For example, display 300 may be presented to an end-user in response to the end-user navigating to a page provided by a content publisher 104 over network(s) 112 (e.g., a page provided by Edmunds.com), where information 304 and 306 corresponds respectively to photograph(s) (and/or video) and specification(s) for a motor vehicle. In some embodiments of the present invention, test drive offer 302 may relate to the same or similar vehicle (e.g., 2010 Kia Forte) identified by information 304 and 306 within display 300. For example, offer 302 may include the text “Free Kia Forte Test Drive” or a similar statement, and may be displayed within display 300 as a result of data (e.g., stored in database 116) associating offer 302 with display 300 (e.g., the Edmunds.com 2010 Kia Forte page). Arrow 308 may indicate that additional information and/or options are available for display, for example, in response to the end-user selecting arrow 308 and/or scrolling down within display 300. In some embodiments of the present invention, in response to an end-user selection of test drive offer 302, the end-user computer 102 associated with the user may request content from the test drive system 110 (e.g., application 120). For example, in response to an end-user selection of offer 302, HTML code associated with offer 302 may direct computer 102 to access a URL administered by system 110.

Advantageously, in some embodiments of the present invention, providing electronic offer(s) to test drive motor vehicles within a display (e.g., page) provided by a source other than the manufacturer(s) or dealership(s) can increase consumer willingness to select the offer, since it can increase consumer confidence in the authenticity of the test drive offer and that it will be conducted without interference from the manufacturer and/or dealership. Moreover, integrating the selectable offer both aesthetically and functionally within the page can further increase consumer comfort and click-throughs of the offer. For example, in some embodiments of the present invention, an electronic test drive offer is provided for display as a selectable button or tab 310 which is positioned in sequence with and general alignment with tabs 312 and 314 corresponding to other options provided within display 300 (e.g., by content publisher 104). In some embodiments of the present invention, test drive offers such as, for example, offer 302 and/or offer 310 may be displayed in pages provided by motor vehicle manufacturer(s) 106, dealership(s) 106, and/or motor vehicle source facilit(ies) 108. In some embodiments of the present invention, displays which are the same or similar to the displays of FIGS. 3, 4, 5, and/or 6 may be displayed to an end-user within an interactive television program guide display, by an application operating on a mobile device 102, and/or by way of a text, graphic, and/or video message displayed on mobile device 102.

FIG. 4 is an illustrative interactive, electronic display 400 through which an end-user can schedule a motor vehicle test drive in accordance with an embodiment of the present invention. For example, display 400 may be displayed to an end-user in response to the end-user selecting test drive offer 302 and/or 310 in FIG. 3. Display 400 may include text information 402 and/or video and/or graphic(s) 404 regarding the test drive offer such as, for example, video explaining how the test drive program works and reiterating that the test drive is free of charge or obligation to the end-user. Alternatively or additionally, display 400 may include information 406, 408, and 410 identifying the make, model, and trim, respectively, of the motor vehicle that will be the subject of the test drive. In some embodiments of the present invention, display 400 may include pull-down list(s) 412, 414, and/or 416 and/or other interactive option(s) that allow the end-user to change the make, model, and/or trim, respectively, of the motor vehicle for the test drive. For example, the selectable options available in the pull-down lists may be predetermined or determined in real time by system 110 based on data stored in database(s) 116, 118, and/or 122 identifying the inventory available at motor vehicle source facilit(ies) 108. End-user selections of options 412, 414, 416 and/or other (e.g., all) interactive options in display(s) generated based on data provided by system 110 (e.g., application 120) may cause end-user computer 102 to submit an additional one or more requests for content to system 110. In response to such request(s), system 110 (e.g., application 120) may return data for display by the end-user computer 102 in one or more displays (e.g., within the same display).

In some embodiments of the present invention, display 400 may include option 418 to allow the end-user to select the date(s) 420 of the motor vehicle test drive. The date(s) selected by the end-user may affect the vehicle make(s), model(s), and/or trim(s) available in lists 412, 414, and 416. Likewise, the make(s), model(s), and/or trim(s) indicated in fields 406, 408, and/or 410 may affect the dates(s) available via option 418. Alternatively or additionally, display 400 may include option 422 selectable by the end-user to have the motor vehicle source facility “Pick me up” for the test drive, or option 424 selectable by the end-user to indicate that “I'll come in” to the facility for the test drive. In some embodiments of the present invention, display 400 may include open-ended response fields requesting the end-user to input contact and/or other information for the end-user including, for example, name 426, email 428, zip code 430, and phone number 432. Arrow 434 may indicate that additional information and/or options are available for display such as, for example, in response to the end-user selecting arrow 434 and/or scrolling down within display 400. A test drive may be scheduled for the end-user and/or the information in data fields 426-432 submitted (e.g., to application 120) in response to an end-user selection of “Reserve Now” option 436. In some embodiments of the present invention, the end-user may be required to submit some or all of the information requested in fields 426-432 prior to scheduling a test drive, for example, to allow application 120 to more accurately identify the date(s) and/or vehicle(s) available for test drives within the end-user's area or region.

FIG. 5 is an illustrative interactive, electronic display 500 that includes information regarding a test drive scheduled for an end-user in accordance with an embodiment of the present invention. For example, display 500 may be displayed to an end-user (e.g., John Doe 502) in response to the end-user submitting valid login credentials within a page provided to end-user computer 102 via system 110 (e.g., application 120). In some embodiments of the present invention, subsequent to a user selection of option 436 (FIG. 4) to schedule a test drive of a motor vehicle, system 110 (e.g., application 120) may create an account for the end-user and email login credentials (e.g., username and password) to the email address provided by the end-user in open-ended response field 428 (FIG. 4).

Display 500 may include information 504 regarding a test drive scheduled for the end-user including, for example, the end-user's name, the vehicle, and the date(s) of the test drive. Alternatively or additionally, display 500 may include option 506 to change some or all of the terms 504 of the test drive (e.g., date(s)). In some embodiments of the present invention, display 500 may include option 508 selectable by the end-user to have application 120 send an electronic reminder for the test drive to an electronic device or account associated with the end-user such as, for example, a text message to the phone and/or an email to the email address identified by the end-user in response fields 432 and 428 (FIG. 4), respectively.

In some embodiments of the present invention, display 500 may include information 510 identifying the location of the vehicle that will be the subject of the test drive (e.g., the location of a motor vehicle source facility 108) and/or option 512 to view (e.g., in one or more displays overlaid upon display 500) and/or download (e.g., in .pdf format) a map of and/or directions to that location. For example, in some embodiments, a motor vehicle manufacturer and/or dealership 106 may pay a vehicle rental facility 108 some or all of a rental fee for a motor vehicle (e.g., a two-day rental) on the end-user's behalf and/or otherwise cover the rental fee, thus establishing a free test drive for the end-user for the rental period and simultaneously decoupling the manufacturer and dealership from the test drive experience. Alternatively or additionally, display 500 may include option 514 to view and/or download information regarding a suggested route for the test drive such as, for example, a scenic or other route identified by data stored by system 110 (e.g., in database 122) as being suitable for a test drive (e.g., a low-traffic route covering both highways and backroads). In some embodiments of the present invention, display 500 may include option 516 to view and/or download a test drive checklist including, for example, suggested aspects regarding the motor vehicle and/or its drive performance that the end-user should observe and/or test during the test drive.

In some embodiments of the present invention, display 500 may include comprehensive vehicle information (e.g., video and/or graphic(s) 518 and/or text 520) for, for example, the motor vehicle which will be the subject of the test drive and/or other vehicle(s). Arrow 522 may indicate that additional information and/or options are available for display, for example, in response to the end-user selecting arrow 522 and/or scrolling down within display 500. Such additional information and/or options may include, for example, link(s) to pages provided by content publisher(s), motor vehicle manufacturer(s) 106, dealership(s) 106, and/or motor vehicle source facilit(ies) 108, an option to view and/or download brochure(s) for the motor vehicle which will be the subject of the test drive and/or other vehicle(s), an option to download audio tour(s) (e.g., MP3 format) regarding the motor vehicle which will be the subject of the test drive and/or other vehicle(s), and/or information regarding awards won by the motor vehicle which will be the subject of the test drive and/or other vehicle(s). In some embodiments of the present invention, display 500 may include option 524 selectable by the end-user to receive assistance (e.g., via a real-time text chat session or telephone call with an employee of the company that provides test drive system 110).

FIG. 6 is an illustrative interactive, electronic display 600 through which an end-user can review and/or provide information regarding a test drive completed by the end-user and/or information regarding purchasing or leasing a motor vehicle in accordance with an embodiment of the present invention. For example, display 600 may be displayed to the end-user within an email received by the end-user subsequent to the test drive. In other examples, display 600 may be displayed by end-user computer 102 in response to the end-user submitting valid login credentials within a page provided to computer 102 via application 120, within an interactive television program guide display, or by an application (e.g., iPhone application) operating on mobile device 102.

In some embodiments of the present invention, display 600 may include information regarding the same or similar motor vehicle which was the subject of the test drive including, for example, vehicle year, make, and/or model 602 and/or graphic(s) and/or video of the vehicle 604. Alternatively or additionally, display 600 may include option 606 selectable by the end-user to view (e.g., in one or more pages provided by, for example, application 120) and/or download (e.g., in .pdf format) specifications regarding the motor vehicle and/or option 608 selectable by the end-user to receive price quote(s) for the same or similar vehicle(s) (e.g., same year, make, and model but different trim). Such price quotes may be provided by system 110 (e.g., application 120) to end-user computer 102 based on, for example, data stored by system 110 (e.g., in databases 116, 118, and/or 122) identifying the prices corresponding to such motor vehicles in the inventor(ies) of one or more dealership(s) 106 within the area or region (e.g., zip code and/or surrounding zip code(s)) of the end-user. In some embodiments, such prices may be adjusted by application 120 based on, for example, any applicable rebate(s) and/or discount(s) available from motor vehicle manufacturer 106 as identified in data stored by system 110.

In some embodiments of the present invention, display 600 may include option 610 to view (e.g., in one or more displays) and/or download (e.g., in fillable .pdf format) an electronic questionnaire requesting, for example, the end-user's feedback regarding the test drive. For example, the questionnaire may include questions aimed at determining the end-user's likes and/or dislikes regarding the motor vehicle which was the subject of the test drive. Alternatively or additionally, the questionnaire may include questions aimed at determining whether the consumer would have test driven the vehicle absent the (e.g., free or subsidized) electronic test drive offer, whether the test drive affected or is likely to affect the end-user's purchase or lease decision, whether the test drive improved the end-user's perception of the vehicle which was the subject of the test drive and/or the vehicle manufacturer, and/or whether the end-user considers aspect(s) of test drive system 110 to be helpful. System 110 (e.g., application 120) may provide information regarding end-user(s)' responses, for example, to motor vehicle manufacturer(s) 106, dealership(s) 106, and/or motor vehicle source facilit(ies) 108 in one or more electronic reports (e.g., via email and/or accessible in one or more pages provided by application 120 in response to receipt of valid login credentials). In some embodiments of the present invention, system 110 may provide motor vehicle manufacturer(s) 106 and/or dealership(s) 106 with contact and/or other information for end-user(s) (e.g., information submitted by end-users in data fields 426, 428, 430, and/or 432 in FIG. 4), for example, to allow manufacturer(s) 106 and/or dealership(s) 106 to follow-up with the end-users regarding purchasing and/or leasing a motor vehicle.

In some embodiments of the present invention, display 600 or other display provided by system 110 may include information regarding one or more motor vehicle(s) other than the vehicle which was the subject of the test drive including, for example, vehicle year(s), make(s), and/or model(s) 612 and/or graphic(s) and/or video(s) 614 of the other vehicle(s). For example, in response to feedback provided by the end-user via electronic questionnaire 610 (e.g., feedback indicating that the vehicle in the test drive lacked sufficient leg room and/or horsepower), application 120 may identify and suggest one or more motor vehicles to the end-user such as, for example, one or more vehicles having more leg room 616 and/or horsepower 618. Such motor vehicle(s) may be identified by application 120 as a result of a comparison between, for example, the data received from questionnaire 610 and data regarding motor vehicles stored by system 110 in databases 116, 118, and/or 122. As another example, application 120 may identify one or more motor vehicles to suggest to the end-user by comparing data regarding motor vehicles to preferences and/or characteristics of the end-user stored by system 110 (e.g., in databases 116, 118, and/or 122). For each suggested motor vehicle, display 600 may include option 620 to view (e.g., in one or more pages provided by, for example, application 120) and/or download (e.g., in .pdf format) specifications regarding the motor vehicle. Alternatively or additionally, display 600 may include option 622 to receive price quote(s) for these vehicle(s), which price quote(s) may be generated based on data stored by system 110 (e.g., in databases 116, 118, and/or 122) identifying the prices corresponding to such motor vehicles in the inventor(ies) of one or more dealership(s) 106 within the area or region (e.g., zip code and/or surrounding zip code(s)) of the end-user. In some embodiments, such prices may be adjusted by application 120 based on, for example, any applicable rebate(s) and/or discount(s) available from motor vehicle manufacturer 106 as identified by data stored by system 110.

In some embodiments of the present invention, display 600 may include arrow 624 indicating that additional information and/or options are available for display, for example, in response to the end-user selecting arrow 624 and/or scrolling down within display 600. In some embodiments of the present invention, display 600 may include option 626 selectable by the end-user to receive assistance (e.g., via a real-time chat session or telephone call with an employee of the company that provides test drive system 110).

Thus it is seen that systems and methods are provided for offering, scheduling, and/or coordinating follow-up communications regarding test drives of motor vehicles. Although particular embodiments have been disclosed herein in detail, this has been done by way of example for purposes of illustration only, and is not intended to be limiting with respect to the scope of the appended claims, which follow. In particular, it is contemplated that various substitutions, alterations, and modifications may be made without departing from the spirit and scope of the invention as defined by the claims. Other aspects, advantages, and modifications are considered to be within the scope of the following claims. The claims presented are representative of the inventions disclosed herein. Other, unclaimed inventions are also contemplated and may be pursued in later claims.

Insofar as embodiments of the invention described above are implementable, at least in part, using a computer system, it will be appreciated that a computer program (e.g., encoded on a computer-readable medium) for implementing at least part of the described methods and/or the described systems is envisaged as an aspect of the present invention. The computer system may be any suitable apparatus, system or device, electronic, optical, or a combination thereof. For example, the computer system may be a programmable data processing apparatus, a general purpose computer, a Digital Signal Processor, an optical computer or a microprocessor. The computer program may be embodied as source code and undergo compilation for implementation on a computer, or may be embodied as object code, for example.

It is also conceivable that some or all of the functionality ascribed to the computer program or computer system aforementioned may be implemented in hardware, for example by means of one or more application specific integrated circuits and/or optical elements. Suitably, the computer program can be stored on a carrier medium in computer usable form, which is also envisaged as an aspect of the present invention. For example, the carrier medium may be solid-state memory, optical or magneto-optical memory such as a readable and/or writable disk for example a compact disk (CD) or a digital versatile disk (DVD), or magnetic memory such as disk or tape, and the computer system can utilize the program to configure it for operation. The computer program may also be supplied from a remote source embodied in a carrier medium such as an electronic signal, including a radio frequency carrier wave or an optical carrier wave.

What is claimed is:

1. Apparatus for electronically scheduling a test drive for an end-user over a communications network, the apparatus comprising:
electronic memory storing data identifying at least one motor vehicle available for a test drive; and
a test drive scheduling application in electronic communication with the electronic memory configured to:
receive a request for content from an end-user computer over a communications network, wherein the request is received by the test drive scheduling application in response to an end-user of the end-user computer selecting an offer for a motor vehicle test drive within an electronic interface display; and
in response to the request, provide data regarding scheduling a test drive of a motor vehicle to the end-user computer over the communications network for display to the end-user by the end-user computer.

2. The apparatus of claim 1, wherein the test drive scheduling application is configured to provide data regarding at least one motor vehicle available for a test drive and at least one date for the test drive to the end-user computer for display by the end-user computer in one or more interactive, electronic displays.

3. The apparatus of claim 2, wherein the test drive scheduling application is further configured to schedule a test drive of a motor vehicle for the end-user in response to receiving from the end-user computer an electronic selection from the end-user within the one or more interactive, electronic displays.

4. The apparatus of claim 3, wherein:
the test drive scheduling application is configured to provide data for a first interactive option to select a motor vehicle type and data for a second interactive option to select a date for a motor vehicle test drive to the end-user computer for display by the end-user computer in the one or more interactive, electronic displays; and
the test drive scheduling application is configured to schedule the test drive of a motor vehicle for the end-user in response to receiving from the end-user computer electronic selections from the end-user in response to the first interactive option and the second interactive option.

5. The apparatus of claim 4, wherein the test drive scheduling application is further configured to provide video data regarding scheduling a motor vehicle test drive to the end-user computer for display by the end-user computer in the one or more interactive, electronic displays.

6. The apparatus of claim 3, wherein the test drive scheduling application is further configured to provide an electronic reminder for the scheduled test drive of the motor vehicle to a computer or an electronic account associated with the end-user.

7. The apparatus of claim 3, wherein the test drive scheduling application is further configured to provide at least one electronic follow-up communication regarding the scheduled test drive to a computer or an electronic account associated with the end-user subsequent to passage or completion of the scheduled test drive by the end-user, wherein the at least one electronic follow-up communication comprises information regarding purchasing or leasing a motor vehicle within a region or area of the end-user.

8. The apparatus of claim 7, wherein the at least one follow-up communication comprises one or more interactive, electronic options requesting feedback from the end-user regarding the scheduled test drive.

9. The apparatus of claim 8, wherein the test drive scheduling application is further configured to provide, based at least in part on information provided electronically by the end-user in response to the one or more interactive, electronic options requesting feedback from the end-user regarding the scheduled test drive, additional data regarding purchasing or leasing one or more motor vehicles for electronic display to the end-user.

10. The apparatus of claim 7, wherein the test drive scheduling application is configured to initiate the at least one electronic follow-up communication in response to receiving over the communications network from a motor vehicle source facility an electronic notification that the scheduled test drive was completed by the end-user.

11. The apparatus of claim 7, wherein the test drive scheduling application is further configured to provide data regarding the scheduled test drive over the communications network to at least one computer associated with at least one of a motor vehicle manufacturer and a motor vehicle dealership.

12. The apparatus of claim 1, wherein the offer for the motor vehicle test drive within the electronic interface display comprises an offer for a motor vehicle test drive that is displayed within a page over the communications network, wherein hypertext markup language (HTML) code is associated with the offer which directs the end-user computer to request content from the test drive scheduling application in response to the end-user selection of the offer for the motor vehicle test drive.

13. The apparatus of claim 1, wherein the offer for the motor vehicle test drive within the electronic interface display comprises an offer for a motor vehicle test drive that is displayed within an interactive television program guide display, and wherein the test drive scheduling application is configured to provide data regarding scheduling a test drive of a motor vehicle to the end-user computer over the communications network for display to the end-user within the interactive television program guide.

14. The apparatus of claim 1, wherein the end-user computer comprises a mobile device, wherein the offer for the motor vehicle test drive within the electronic interface display comprises an offer for a motor vehicle test drive that is displayed on a mobile device by an application operating on the mobile device, and wherein the test drive scheduling application is configured to provide data regarding scheduling a test drive of a motor vehicle to the mobile device over the communications network for display to the end-user by the application operating on the mobile device.

15. A computer-implemented method for electronically scheduling a test drive for an end-user over a communications network, the computer-implemented method comprising:
storing in electronic memory data identifying at least one motor vehicle available for a test drive;
receiving with a computer comprising a server an electronic request for content from an end-user computer over a communications network, wherein the electronic request is received by the computer in response to an end-user of the end-user computer selecting an offer for a motor vehicle test drive within an electronic interface display; and
in response to the request, providing with the computer comprising the server data regarding scheduling a test drive of a motor vehicle from the electronic memory to the end-user computer over the communications network for display to the end-user by the end-user computer.

16. The computer-implemented method of claim 15, wherein providing data regarding scheduling a test drive with the computer comprising the server comprises providing with the computer comprising the server data regarding at least one motor vehicle available for a test drive and at least one date for the test drive to the end-user computer for display by the end-user computer in one or more interactive, electronic displays.

17. The computer-implemented method of claim 16, further comprising scheduling with the computer comprising the server a test drive of a motor vehicle for the end-user in response to receiving from the end-user computer an electronic selection from the end-user within the one or more interactive, electronic displays.

18. The computer-implemented method of claim 17, wherein:
providing data regarding scheduling a test drive with the computer comprising the server comprises providing with the computer comprising the server data for a first interactive option to select a motor vehicle type and data for a second interactive option to select a date for a motor vehicle test drive to the end-user computer for display by the end-user computer in the one or more interactive, electronic displays; and
wherein the method further comprises scheduling the test drive with the computer comprising the server for the end-user in response to receiving from the end-user computer electronic selections from the end-user in response to the first interactive option and the second interactive option.

19. The computer-implemented method of claim 17, further comprising providing with the computer comprising the server an electronic reminder for the scheduled test drive of the motor vehicle to a computer or an electronic account associated with the end-user.

20. The computer-implemented method of claim 17, further comprising providing with the computer comprising the server at least one electronic follow-up communication regarding the scheduled test drive to a computer or an electronic account associated with the end-user subsequent to passage or completion of the scheduled test drive by the end-user, wherein the at least one electronic follow-up communication comprises information regarding purchasing or leasing a motor vehicle within a region or area of the end-user.

21. The computer-implemented method of claim 17, further comprising providing with the computer comprising the server data regarding the scheduled test drive over the communications network to at least one computer associated with at least one of a motor vehicle manufacturer and a motor vehicle dealership.

22. A computer-readable medium comprising computer-executable instructions recorded thereon for performing the method comprising:
receiving an electronic request for content from an end-user computer over a communications network, wherein the electronic request is received in response to an end-user of the end-user computer selecting an offer for a motor vehicle test drive within an electronic interface display; and
in response to the request, providing data regarding scheduling a test drive of a motor vehicle to the end-user computer over the communications network for display to the end-user by the end-user computer.
